(19) United States
(12) Patent Application Publication
(10) Pub. No.: US 2005/0007954 A1
(43) Pub. Date: Jan. 13, 2005

(54) Network device and method for categorizing packet data flows and loading balancing for packet data flows

(75) Inventors: Srinivas Sreemanthula, Flower Mound, TX (US); Haihong Zheng, Coppell, TX (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/860,585

(22) Filed: Jun. 4, 2004

Related U.S. Application Data
(60) Provisional application No. 60/486,212, filed on Jul. 11, 2003.

(51) Int. Cl. H04L 12/26

(52) U.S. Cl. 370/229

(57) ABSTRACT

A method of load balancing for packet data flows in a packet data network is provided. According to one embodiment, the method includes the steps of receiving a packet data flow and verifying whether the packet data flow belongs to one of the existing packet data delivery categories. The method also includes the steps of assigning a first delivery path indicator for the packet data delivery category, retrieving load conditions prevailing in the network, and checking whether one of the existing packet data delivery categories conforms to prescribed resource policy rules for one of the existing packet data delivery category. When the step of checking generates a negative result, the method involves the step of assigning an alternative delivery path indicator for the packet data delivery category. The invention also provides a method of categorizing packet data flows as belonging to a certain packet data delivery category.

### CROSS-REFERENCE TO RELATED APPLICATIONS

This application claims priority of U.S. Provisional Patent Application Ser. No. 60/486,212 entitled, “A Method of Categorizing Packet Data Flows, Method of Load Balancing for Packet Data Flows, and Network Device Therefor,” filed Jul. 11, 2003, the entire contents of which are incorporated herein by reference.

### BACKGROUND OF THE INVENTION

1. Field of the Invention

The invention relates to a method of categorizing packet data flows as belonging to a packet data delivery category, a method of load balancing for packet data flows in a packet data network, and to a correspondingly adapted network device.

2. Description of the Related Art

Recently, communication technology has increasingly captured the attention of users and therefore its use has widely spread. Also, currently there is a tendency in that circuit switched communication technology is more and more being replaced by packet-switched communication technology.

Packet-switched communication technology is based on so-called packet-based communication networks. This means that data is transmitted in units of packets which may but need not travel via the same route or path within the network, and thus most probably arrive at different times at the destination, where they are re-ordered. Transmission and reception of the packets is based on the organization of the information carried in a header of a respective data packet (a packet as such being composed of the header and the payload section).

One of the best known examples for such packet switched networks is the Internet. Another example is an Asynchronous Transfer Mode protocol (ATM) network.

Generally, the invention as described below concerns any packet switched communication network and packet-switched transmission protocol such as the Internet Protocol IP (whether in its fourth (IPv4) or sixth (IPv6) version), ATM, Frame Relay protocol, or any other packet switched protocol currently existing or being developed.

Also, the invention concerns packet switched communication networks and the underlying technology, which enable the usage or transmission of a plurality of the above mentioned packet data protocols within or via the same communication network and/or network domain, while every data packet of an individual protocol type is treated as the data packet of another individual protocol type. Hereinafter, those packet-switched communication networks are referred to as “combination-hybrid” protocol networks.

A typical example of such “combination-hybrid” protocol network is the Multi-Protocol Label Switching (MPLS) network. With reference to the Open System Interconnection (OSI) layer model, MPLS is often referred to as layer 2.5 protocol since it is located between the data link layer (Layer 2) and the network layer (Layer 3).

However, the invention is not limited to this MPLS network or MPLS protocol. Rather, any other “combination-hybrid” protocol and network may be concerned such as (still with reference to the OSI layer model) layer 1.5, layer 3.5, layer 4.5, layer 5.5, or layer 6.5 protocols/networks. Packet data transmitted on a specific layer mostly differ from packet data transmitted on another (higher or lower) layer only in the information carried in the respective header of the packet.

Nevertheless, for the subsequent more detailed description of the invention, a focus is laid on the MPLS as an example. The MPLS is considered to be known by one skilled in the art since it has been under discussion by the Internet Engineering Task Force (IETF) since the late 1990's. Therefore, a detailed description of the MPLS protocol is not provided within this discussion. However, the interested reader is referred to the following references:
1. “MPLS Architecture”, by Gautham Pamu, CS590F-Design of MultiService Networks, retrieved from the Internet under http://www.cs.purdue.edu/homes/fahmy/cs590f/talks/pamu/mpls.ppt and
2. “MPLS (Multi Protocol Label Switching)”, by Sinduja Murari and Eli Snell, CSC 564, Winter 2002, Feb. 26, 2002, retrieved from the Internet under http://www.csc.calpoly.edu/˜husmith/CSC564-Winter02/mpls_paper.pdf; both of which are incorporated herein by reference as they provide a comprehensive summary of the principles underlying MPLS.

For the subsequent explanations, the terminology as agreed upon under the MPLS protocol will be used, while it is noted that in connection with other “combination-hybrid” protocols a corresponding but different terminology may be used.

In typical MPLS networks, congestion produced on one of a virtual link (a so-called label switched path or simply route) may be de-congested by allowing an ingress router to map data over a new link (new label switched path). For example, if it is reported to the ingress router that traffic along a specific link should be reduced by 20%, the ingress router may map one in every five packets onto a new virtual link. However, the problem with blindly re-directing data packets along a new link is that it may not actually alleviate congestion on the intended link since the size of each redirected data packet is not known and data flows are disrupted, which means that the packets are received out of sequence and loss of data packets may occur.

Out of sequence data flows may cause reduction in the quality of service for certain services, such as Voice over IP (VoIP), and may cause possible inefficient use of resources since out of sequence packets may cause an acknowledgment by the receiver that some packets were not received and should be resent, which in turn may cause a reduction in throughput across the network.

In addition, tests show that blindly re-mapping data packets over new links results in a loss of up to 30% of data packets.

In particular, Label Switched Path (LSP) or Explicit-Label Switched Path (E-LSP) establishment in the MPLS networks does not guarantee any particular amount of resource usage on that LSP. Forwarding Equivalence Classes FECs for packets/flows are conventionally allocated based on certain IP header information only. Therefore, the nodes must explicitly implement, limit and police the resource usage on various LSPs.

Load balancing techniques for MPLS-TE networks (TE: Traffic Engineering) are still at their infancy. Current MPLS load-balancing techniques involve performing load balancing at a packet level. This disrupts the flows resulting in significant out-of-order packets.

Document U.S. Pat. No. 6,111,877 discloses a load balancing technique across flows. Flows are distributed across various queues by marking received data packets for a particular flow and distributing it to a particular queue according to the load balancing scheme. Again, this disrupts the flows resulting in significant out-of-order packets.

### SUMMARY OF THE INVENTION

According to one embodiment of the invention, a method of categorizing packet data flows as belonging to a packet data delivery category is provided. The method includes the steps of receiving, verifying, determining, checking and assigning. The receiving step receives a packet data flow in an entity. The verifying step verifies that the packet data flow belongs to none of existing packet data delivery categories in the entity. The determining step determines whether characteristics of the packet data flow match one of the existing packet data delivery categories. The checking step checks whether one of the existing packet data delivery categories conforms to prescribed resource policy rules for the one existing packet data delivery category. The assigning step assigns the packet data flow to the one existing packet data delivery category.

According to another embodiment of the invention, a method of load balancing for packet data flows in a packet data network is provided. The method includes the steps of receiving, detecting assigning, retrieving, checking and assigning. The receiving step receives a packet data flow in an entity. The detecting step detects an enablement for load balancing for the packet data flow belonging to one of the existing packet data delivery categories in the entity. The assigning step assigns a first delivery path indicator for the packet data delivery category. The retrieving step retrieves the load conditions prevailing in the network. The checking step checks whether one of the existing packet data delivery categories conforms to prescribed resource policy rules for one of the existing packet data delivery category. The assigning step assigns an alternative delivery path indicator for the packet data delivery category, in case the step of checking has a negative result.

According to yet another embodiment of the invention, a network device is provided. The network device includes a receiver, and a categorizing device, which includes a verification mechanism, a determining mechanism, a checking mechanism, and an assignment mechanism. The receiver receives a packet data flow in the network device. The categorizing device is supplied with the received packet data flow. The verification mechanism verifies that the packet data flow belongs to none of existing packet data delivery categories in the network device. The determining mechanism determines whether characteristics of the packet data flow match one of the existing packet data delivery categories. The checking mechanism checks whether one of the existing packet data delivery categories conforms to prescribed resource policy rules for one of the existing packet data delivery category. The assignment mechanism assigns the packet data flow to one of the existing packet data delivery category.

According to still another embodiment of the invention, a network device including a receiver and a load balancing device is provided. The receiver receives a packet data flow in the network device. The load balancing device is supplied with the received packet data flow. The load balancing device includes a detection mechanism, an assignment mechanism, a retrieval mechanism and a checking mechanism. The detection mechanism detects an enablement for load balancing for the packet data flow belonging to one of the existing packet data delivery categories in the network device. The assignment mechanism assigns a first delivery path indicator for the packet data delivery category. The retrieval mechanism retrieves load conditions prevailing in the network. The checking mechanism checks whether one of the existing packet data delivery categories conforms to prescribed resource policy rules for the existing packet data delivery category. In response to a negative result output by the checking mechanism, the assignment mechanism assigns an alternative delivery path indicator for the packet data delivery category.

This invention advantageously provides ways to manage MPLS traffic and perform load balancing on the flow level. The invention performs load balancing with reference to individual flows, and in connection therewith, packet data delivery categories, such as Forwarding Equivalence Classes FECs according to MPLS, for packets/flows are advantageously allocated based on a relation of packet data delivery categories (FEC) and resource-usage.

Stated in other words, previously the FEC rules at a network device, e.g. a router such as the ingress node, only determined the identification of the packet data delivery class FEC based on the flow identifier information as contained e.g. in the IP header information. However, previously there was no mechanism to use this information in connection with the resource availability or usage information, whereas this invention presents mechanisms to do so.

That is, the invention combines resource management (e.g. bandwidth related) and MPLS LSP management. Particularly, it allows the extension of an FEC allocation based on IP flow information to additionally allocating FECs based on resource availability. According to this invention, for a given time period the resource usage (bandwidth and/or other parameters identifying the transmission link resource) is monitored on an FEC basis. As an application to this invention, when a need for load balancing is detected, the FEC represented by at least one flow (or a set of flows) can be directly mapped to a different delivery path indicator such as an Next Hop Label Forwarding Entry (NHLFE) entry according to MPLS, indicating a secondary path. This mechanism then allows that all the flows within the packet delivery category FEC are now directly switched to a secondary path resulting in flow-based load balancing.

Thus, as stated above, the invention proposes a monitoring and recording of resources allocated to a set of flows of a packet delivery category such as a forwarding equivalence class FEC and current usage of resources for each flow mapped onto a virtual link such as a Label Switched Path LSP for purposes of load balancing. Resource allocation between two network devices (network nodes and/or routers) may be dependent on, for example, the application and service type and is set during a session establishment. When congestion occurs at a node within, e.g. the MPLS network, resource usage on a congested link is reported back to the ingress node. The ingress node takes into consideration the amount of resources allocated per flow, its current resource usage, and the requirements in reduction in traffic along the congested link to reduce resource usage to an acceptable level. From this information, the ingress node can simply and efficiently identify a set of flows directed along the link that if re-mapped over a new link will relieve congestion over the congestive link. By monitoring the required resource allocation and current resource usage per flow, effective load balancing techniques may be used to simply and efficiently alleviate congestion over a particular link without the effects of out of sequence data packets mentioned above. Thus, retaining resource requirements and current resource usage per flow is used for load balancing and provides the above mentioned significant advantage.

### BRIEF DESCRIPTION OF THE DRAWINGS

In the following, the invention will be described in greater detail with reference to the accompanying drawings, in which

FIG. 1A shows a basic flowchart illustrating the aspect of load balancing for packet data flows in a packet data network, according to the invention;

FIG. 1B shows a basic flowchart illustrating the aspect of categorizing packet data flows as belonging to a certain packet data delivery category, according to the invention;

FIG. 2 shows a simple block circuit diagram of a categorizing device and input/output relations;

FIG. 3 shows a diagram illustrating an example situation of load balancing and flow re-routing;

FIG. 4 shows a resource management table;

FIG. 5 shows a FEC-To-NHLFE (FTN) table;

FIG. 6 shows an example of a possible MPLS network domain.

### DETAILED DESCRIPTION OF THE PREFERRED EMBODIMENTS

It is to be noted that the invention will be described with a specific focus on an MPLS network as a “combination-hybrid” network and thus MPLS specific terminology is frequently used herein. Nevertheless, the invention is not limited to MPLS networks and but is applicable also to other types of “combination-hybrid” networks, for which one might use other terminology.

When, for example, in most general terms a “packet data delivery category” is concerned, this corresponds to a Forwarding Equivalence Class (FEC) in MPLS terminology, but may be named differently for other “combination-hybrid” networks. Irrespective of the specific terminology used, a packet data delivery category is intended to define a specific common treatment in terms of transmission or delivery of packet data belonging to a respective one of such categories. The treatment can be expressed in terms of transmission speed such as bit rate or any other quality of service QoS parameter or even combination of such parameters. Additionally or alternatively, the treatment can be expressed in terms of a route or path chosen for the delivery of the packet data belonging to a respective one of such categories.

Also, when, for example, in most general terms a “delivery path indicator” is concerned, this corresponds to an entry in an FTN table in MPLS terminology, but may be named differently for other “combination-hybrid” networks. (FTN=FEC-to-NHFLE, i.e. Forwarding Equivalence Class to Next Hop Forwarding Label Entry.) Irrespective of the specific terminology used, a delivery path indicator is intended to define an information for a router as a network device indicating at least one next hop (partial delivery path from one router or network node to the next one) for data packets to be delivered to their destination. A single delivery path indicator may nevertheless also specify two or more subsequent hops for data packets to be delivered.

A packet flow is intended to define a plurality of individual packets which are linked or associated to each other, e.g. in terms of a common origin (sender) and a common destination (receiver). A packet flow is identified by a flow identifier. The flow identifier is represented by the information carried in a packet, which is used to identify if the packet belongs to a particular flow. The flow identifier may be, when referring to Ipv4 as an example, the combination of source address, destination address, protocol id, source port number and destination port number. When referring to Ipv6 as an example, the flow identifier may be the combination of source address and flow label. Other flow identifier may be used besides the ones listed above, e.g. in the case where an ATM or Frame Relay packet data protocol is concerned. It's not within the scope of this document to discuss what is the flow identifier. The term flow identifier is used in the following discussion.

FIG. 6 shows an example of a possible MPLS network domain. The domain is part of an overall network architecture (not shown) and communicates with the “rest” of the network architecture and/or directly with terminals. The domain is constituted by a plurality of network nodes or routers (more generally, network devices). IN MPLS, a router operates using the concept of label switching and is thus referred to as label switching router LSR. A router at the border of the domain is referred to as edge router. An edge router to which an incoming packte data flow is input is referred to as an ingress router. An edge router at which an outgoing packte data flow is output (from the domain) is referred to as an egress router. Routers between an ingress and an egress router are referred to as transit routers. FIG. 6 shows an ingress, an egress and three transit routers and their interconnections as an example. Other numbers of transit routers are possible. The arrow in FIG. 6 represents the incoming and outgoing data flow. Within the domain, data flows may take different paths LSP, e.g. from the ingress LSR via the transit LSR1 to the egress router, and/or from the ingress LSR via the transit LSR2, LSR3 to the egress router, or any other route or path possible within the domain due to the router interconnections provided. It is to be noted that as shown in FIG. 6 also LSR1 and LSR3 are accessible from the “external” overall network architecture, and thus also these routers may act as ingress or egress routers in connection with a specific data flow. Likewise, an ingress router may simultaneously act as an egress router in case it handles numerous flows.

FIG. 2 shows an example of a simple block circuit diagram of a categorizing device and input or output relations. This categorizing device is for example part of a router which has a receiver (not shown) receiving packet data flows. The received flows are represented by the arrows denoted with a,b,c, which are referred to as an example, but may include more flows as indicated by the dotted arrow. The protocol underlying a respective packet flow is arbitrary and may be IP, ATM or the like.

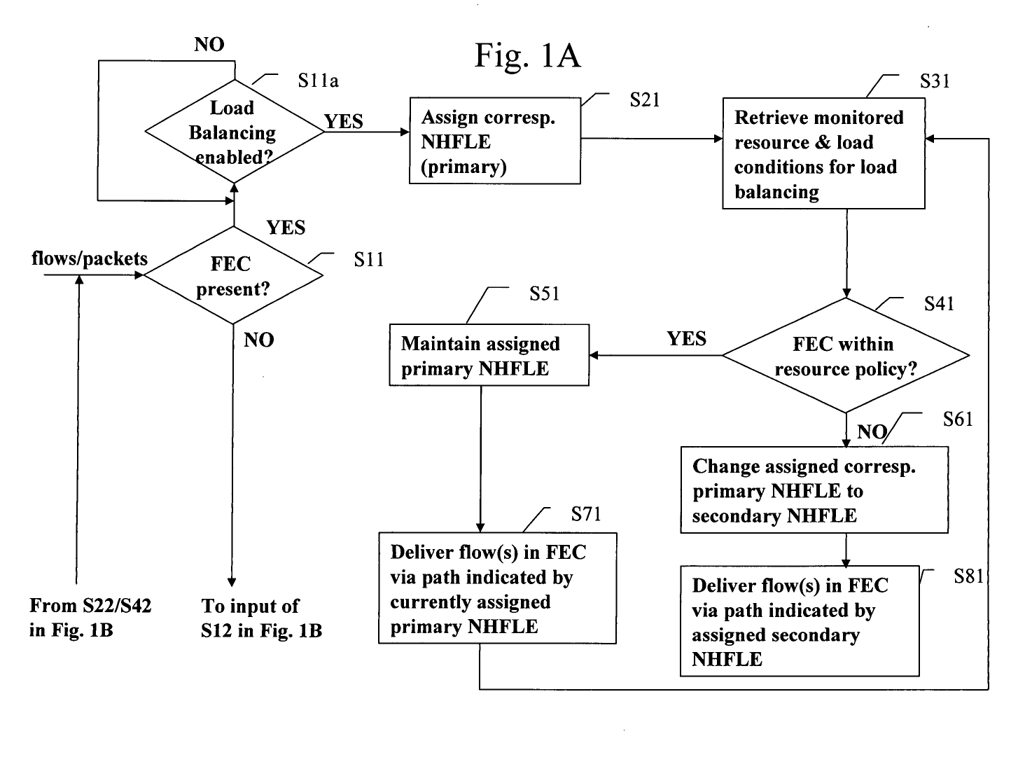

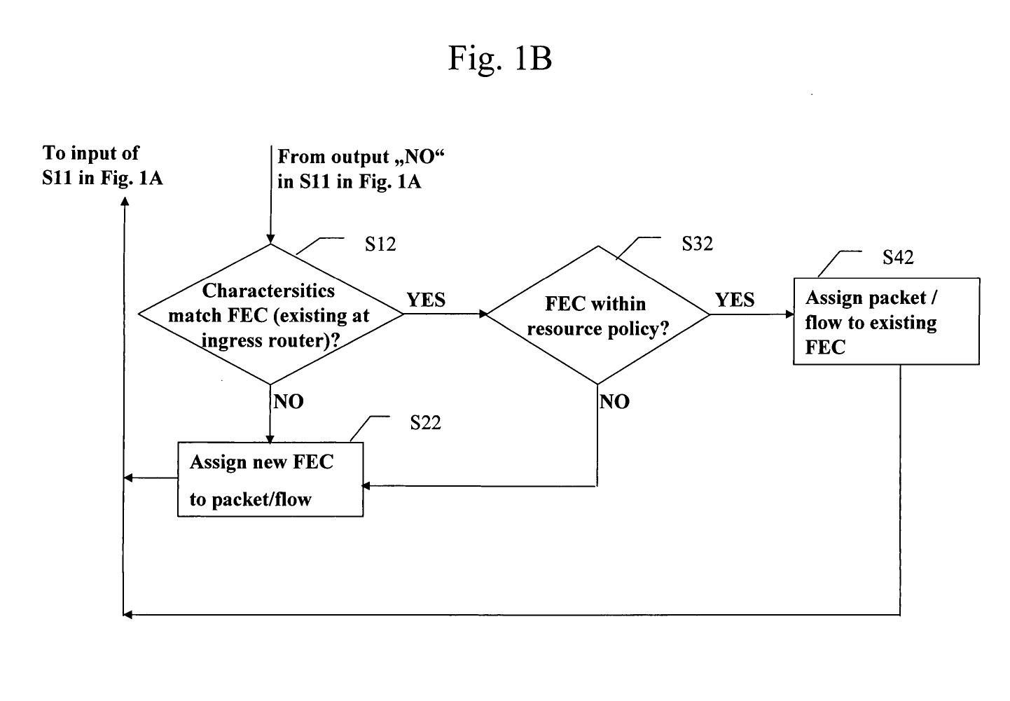

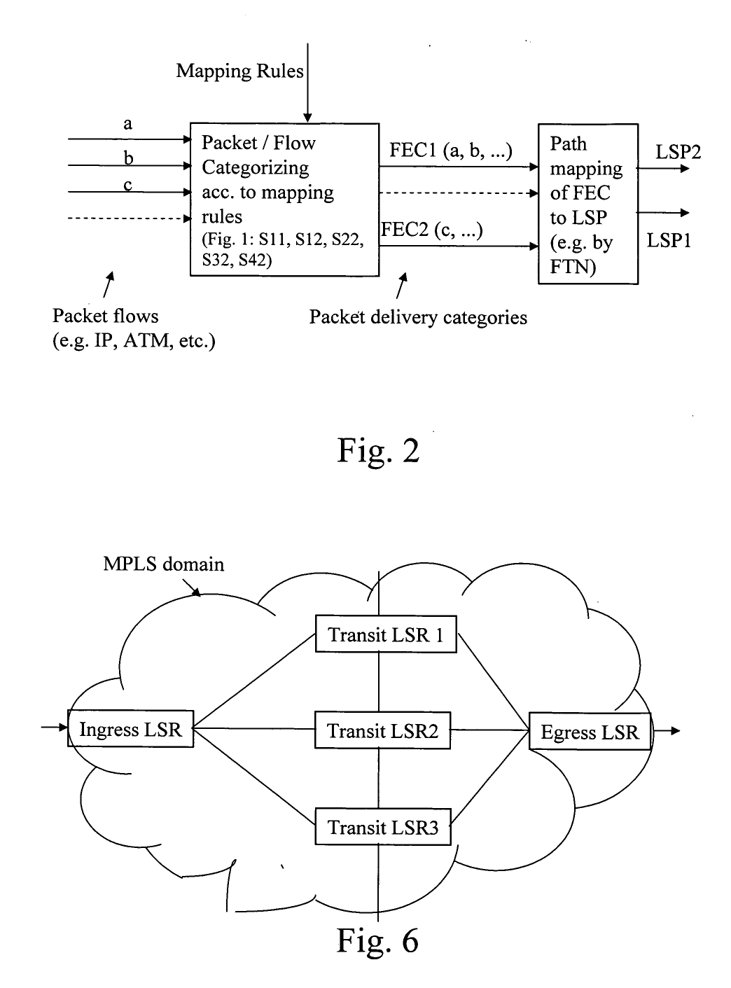

The categorizing device can be supplied with the received packet data flows, and also with mapping rules defined by e.g. an operator of the MPLS network. The mapping rules are stored internally in a memory of the device. When applying the mapping rules to the incoming flows (details are to be described with reference to FIG. 1), the flows are categorized in packet delivery categories such as Forwarding Equivalence Classes FEC1, FEC2, etc. (Other FECs are indicated by a dotted arrow.) For the considered example, FEC1 and FEC2 are sufficient for explanatory purposes. As shown in FIG. 2, flows a, b were assigned to FEC1, while flow c was assigned to FEC2.

Subsequently, the FECs can be subjected to a path mapping in a path mapping device, i.e. each FEC is assigned a label switched path LSP through the MPLS domain. This mapping, according to MPLS, is achieved by means of a FTN table. The mapped paths are indicated by the arrows LSP1, LSP2.

FIG. 1A shows a basic flowchart illustrating the aspect of load balancing for packet data flows in a packet data network, according to one embodiment of the invention. FIG. 1B shows an example of a basic flowchart illustrating the aspect of categorizing packet data flows as belonging to a packet data delivery category, according to the invention. The flowcharts represent individual method steps or represent devices equipped with corresponding functional elements within a network device such as a router. Any of these elements may be realized either in hardware or in software.

With reference to the example shown in FIG. 1A, a packet data flow is received, which is subjected to a step S11 which verifies whether the packet data flow belongs to none of existing packet data delivery categories. In particular, it is checked based on a delivery category identifier (e.g. carried in the header of the packets) whether, and if which of, a FEC is present or already assigned to the packet data flow or not.

In case the verification is positive, i.e. no FEC is present, the method proceeds to step S12 in FIG. 1B. In step S12, it is determined whether characteristics of the packet flow match an FEC which already “exists” and/or is managed at the router. If so, (YES in S12) the method proceeds to step S32 to check whether one FEC, i.e. one of the existing packet data delivery categories, conforms to prescribed resource policy rules for one of the existing packet data delivery category. If so, the method proceeds to step S42 to assign the packet data flow to one of the existing packet data delivery category. The resource policy rules are operator defined. The resource may be defined in terms of (available) bandwidth (e.g. bit rate) or any other suitable parameter for defining or identifying resources (e.g. available frequencies or the like). An FEC is said to be “within the resource policy” if for example the maximum bandwidth is not exceeded, or a certain safety margin of bandwidth is still present, or the like. Further measures of resources or resource usage are for example packet data flow rates averaged over a certain time period, queue sizes, etc. In this regard, the step S32 involves monitoring of the resource usage by existing packet data flows on a FEC basis. The FECs are assigned based on a certain maximum usage limit of resources and monitoring provides a knowledge of the current usage. Also, based on a knowledge of the current resource usage, a knowledge of an expected resource usage in case of assigning a further flow to a specific FEC can be obtained. The conformity of the FEC to the resource policy can thus be determined (in step S32) based on the current resource usage and/or on the expected future resource usage. Stated in other words, a current resource usage of an FEC may be within the resource policy, whereas an expected resource usage of the FEC upon assigning a further flow to the FEC may no longer be within the resource policy.

However, in the case where the step of determining S12 generates a negative result, the method proceeds to step S22 to assign a new packet data delivery category to the packet data flow. This means that a previously not existing FEC is newly defined.

Similarly, in the case where the step of checking S32 generates a negative result, the processing proceeds to step S22 of assigning a new packet data delivery category to said packet data flow.

Either after step S22 or after step S42 the processing returns to the input of step S11, with the flow now being assigned a packet delivery category so that an FEC is present. In this case the verification in step S11 (that the packet data flow belongs to none of existing packet data delivery categories) is “negative” because it is determined that an FEC is present (YES in step S11). Thereafter, the method proceeds to steps S11a, S21, 31, 41, 51, 61, 71, respectively, which are subsequently described.

These steps implement the method of load balancing for packet data flows in a packet data network.

As shown in the example of FIG. 1A, the method can include the steps of receiving a packet data flow (supplied to step S11), and verifying in step S11 that the packet data flow belongs to one of the existing packet data delivery categories such as FEC.

If this has been verified (YES in step S11) the method proceeds to step S11a. In step S11a it is determined whether a load balancing is enabled to be performed or not. This determination is for example based on whether a service feature of load balancing is active or activated and load balancing is thus enabled to be performed. This is specific to an FEC and/or specific to a network device. In case such a load balancing feature is not detected to be enabled (NO in step S11a), the method loops back to step S11a. If a load balancing feature is detected to be enabled (YES in step S11a), the method proceeds to step S21 to assign a first delivery path indicator for the packet data delivery category. In the case of MPLS, a FTN table is used for this purpose. Then, this assigning is represented by assigning a corresponding primary NHFLE to the FEC. Stated in other words, at least the next hop for packet data transmission is specified for the FEC using a corresponding data entry which is in the FTN table.

Subsequently, the router or generally the network device performs at step S31, a retrieving of load conditions prevailing in the network. The load conditions are monitored based on measurements carried out throughout the network in a decentralized manner, i.e. each router LSR monitors the paths by which it can be accessed and/or by which it can access other LSR routers and reports the result to another node. Stated in other words, each intermediate node in the MPLS network monitors and provides current load conditions to an element of the network, whether that is an element of the MPLS network or of an adjacent network. The ingress node retrieves this information from this element and uses it for load balancing purposes. The resource information, i.e. maximum resource allocation and current resource usage, associated to a particular flow is established downstream and/or upstream by the application clients of endpoints (communication partners, i.e. transmitter terminal and receiver terminal) and the access networks. This resource information is provided to the ingress node so that the ingress node uses particular resource information associated with each flow, along with the congestion reports, to more effectively alleviate congestion on the identified links without causing the problems identified in the traditional methods mentioned above. How this is achieved will become clear from the further description of the Figures.

Namely, in a subsequent step S41 the router and/or a load balancing device of the router performs a checking that one of the existing packet data delivery categories conforms to prescribed resource policy rules for one of the existing packet data delivery category. This means that it is checked whether the FEC is still within a predefined resource policy, i.e. that it does not violate bandwidth requirements or the like.

In the case where the step of checking S41 generates a negative result, the method proceeds to a step S61 of assigning an alternative delivery path indicator for the packet data delivery category. In the case of a MPLS, a FTN table is used for this purpose. Then, this assigning is represented by assigning a corresponding secondary NHFLE to the FEC. Stated in other words, an alternative including at least the next hop for packet data transmission is specified for the FEC using a corresponding data entry which is in the FTN table.

It is to be noted that the invention is not limited to the usage of a primary and secondary delivery path indicator such as the primary and secondary NHFLE, but that also e.g. a ternary NHFLE may be used. Also, it is to be noted that each of such delivery path indicators is predefined and that the assignment is actually effected by selecting or activating one of these for use in delivering of flows. The selection and/or activation is represented and indicated by setting a corresponding flag.

The process then proceeds to a step S81 of delivering the packet data flow belonging to one of the existing packet data delivery categories via the path indicated by the currently assigned delivery path indicator, i.e. by the alternative (e.g. secondary) delivery path indicator.

In contrast thereto, in case the step of checking, S41, generates a positive result, the method proceeds to a step S51 of maintaining the assigned primary delivery path indicator (i.e. a flag previously set is not changed).

After step S51, the method proceeds to step S71 to deliver the packet data flow belonging to one of the existing packet data delivery categories via the path indicated by the currently assigned primary delivery path indicator.

Of course, the step S31 of retrieving load conditions prevailing in the network is repeatedly performed, as is indicated by the “feedback loop” from step S71 to step S31. The term “Repeatedly” means either continuously or in regular or irregular intervals. This may then lead to a situation in which the primary path used for a certain FEC violates the resource policy and as a consequence thereof, is switched to the secondary LSP.

By virtue of this arrangement, traffic paths are not switched back and forth between primary and secondary, as this may result in packet out-of-ordering in the network. A primary path is the main path and the secondary (or ternary) represents an alternative “backup” to the primary. Whether the secondary or e.g. ternary is selected as the alternative to the primary may be decided on various conditions such as a “degree of violation of the resource policy” of the FEC (determined in step S41 or a subsequent step S41a (not shown)), measured e.g. in percentage of an allowable limit, or the like.

Thus, the traffic is kept on the alternative path, e.g. the secondary, once switched thereto from the primary, and switched flows will continue and “die” there. In due course, if the primary path becomes compliant to the resource policy afterwards, newborn flows will be assigned to the primary path. Hence, there is no checking of whether the alternative path such as the secondary meets the resource policy. If, however, the secondary path cannot handle the traffic, packet drop mechanisms already defined at the network routers will handle such a situation.

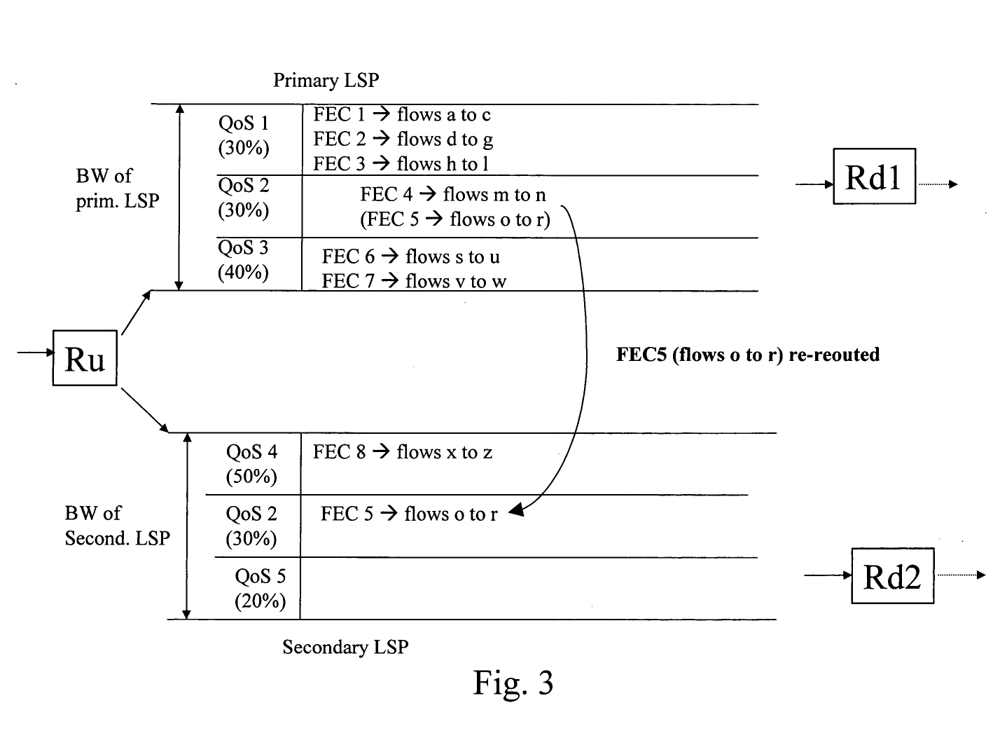

FIG. 3 shows a diagram illustrating an example situation of load balancing and flow re-routing as described above with reference to FIG. 1A. The term “Ru” denotes an upstream router, e.g. an ingress router, and the terms “Rd1” and “Rd2” denote downstream routers, such as LSR1, LSR2, LSR3 in FIG. 6, to which an incoming packet flow (represented by the arrow entering Ru) is delivered. A primary label switched path LSP1 is assumed to be set up between Ru and Rd1, and a secondary LSP, LSP2 is assumed to be set up between Ru and Rd2. (Note that the notation primary and secondary is chosen with reference to a particular flow being considered, as explained later on.) Each path is characterized by a maximum available bandwidth assigned thereto. Within each path, different types or classes of Quality of Service QoS may be present. In the illustrated example, LSP1 handles QoS classes QoS1, QoS2, QoS3 being allowed to use a bandwidth of LSP1 of 30%, 30%, and 40%, respectively. LSP2 handles QoS classes QoS4, QoS2, QoS5 being allowed to use a bandwidth of LSP2 of 50%, 30%, and 20%, respectively. Note that the names of the QoS classes as well as their assigned percentage of bandwidth (BW) consumption are arbitrarily chosen and may differ in another example.

Within a respective QoS, different FECs are handled. For example, in regard of LSP1, FEC1 to FEC3 are handled in QoS1, FEC4 and FEC5 are handled in QoS2, and FEC6 and FEC7 are handed in QoS3, whereas in regard of LSP2, FEC8 is handled in QoS4, and FEC5 (re-routed) is handled in QoS2. As shown in FIG. 3, QoS5 is not assigned any FEC, while this is illustrated in this way only to simplify the explanation.

Within a respective FEC, different flows are handled. With reference to the illustrated example, FEC1 includes flows a to c, FEC2 includes flows d to g, FEC3 includes flows h to l, FEC4 includes flows m to n, FEC5 includes flows o to r, FEC6 includes flows s to u, FEC7 includes flows v to w, and FEC8 includes flows x to z.

It is now assumed that in regard of assigned flows o to r, or FEC5 (within QoS2) on the primary LSP, LSP1, there will occur a violation of the resource policy for FEC5 (or even for QoS2 class (e.g. QoS2 class traffic may then use more than 30% of the overall bandwidth of LSP1). Stated in other words, FEC5 may have been safely assigned previously and a certain flow with the FEC changes in that e.g. more packets are delivered within the flow, so that FEC5 will violate the resource policy rules.

Then, as described with reference to the example shown in FIG. 1A, steps S41, S61, FEC5 including flows o to r will be rerouted to LSP2, as shown in FIG. 3. However, it is not necessary that the flows o to r in FEC5 are re-routed. Rather, any flow within the respective QoS2 class may be selected to be re-routed if it frees sufficient resources, i.e. the resource policy for a QoS class and/or FEC is not violated. This means that in another case (not shown) FEC4 may be rerouted to its secondary path. Also, the secondary path for FEC4 need not be LSP2, but may be another path to another downstream router Ru (not shown in FIG. 3). Stated in other words, the assignment of a primary and secondary path is specific for a respective FEC.

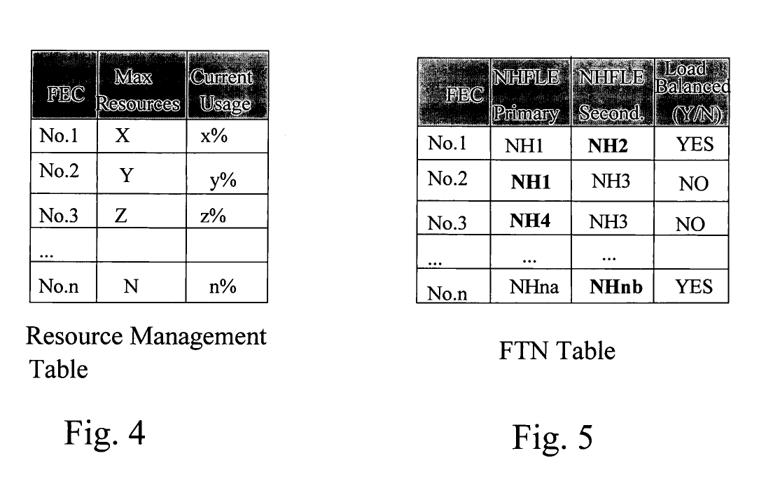

FIG. 4 shows an example of a resource management table. The table contains three columns labeled “FEC”, “max resources”, and “current usage”. The “FEC” column indicates the name of the FEC such as “No.1”, No.2”, . . . to “No.n” (or FEC1 to FEC8 when referring to FIG. 3). The column “max resources” indicates the maximum resource a certain FEC is allowed to use. The maximum resources can be expressed in an absolute number (denoted as “X”, “Y”, “Z”, “N” in FIG. 4) of e.g. the bandwidth available. The “current usage” column contains the retrieved results of monitoring resource and load conditions for individual FECs and is for example expressed in a percentage (denoted as x%, y%, z%, n% in FIG. 4) of the maximum resources of each FEC. The ingress router is enabled to act alone and to set the load balancing status for a certain FEC based on its own resource monitoring, in addition to other network nodes providing this information. One way is that there is a centralized node that monitors the network load and collects information which concerns all downstream nodes, and this node provides a succinct information to the ingress node of the status so that the ingress node can act on based on features explained in this application. Nevertheless, there are other open/proprietary protocols to carry this information to the ingress node.

FIG. 5 shows an example of a FTN table. The FTN table contains four columns labeled “FEC”, “NHFLE primary”, “NHFLE secondary” and “load balanced Y/N”. The “FEC” column indicates the name of the FEC such as “No.1”, No.2“, . . . to “No.n” (or FEC1 to FEC8 when referring to FIG. 3). Each of the “NHFLE primary”, “NHFLE secondary” columns contains an entry which specifies at least the next hop for packet flows, i.e. the subsequent downstream router to which the packet flow is to be delivered. This is for example accomplished by indicating the address of the router, e.g. as NH1, NH2, NH3, NH4, Nhna, NHnb, or the like. The column “load balanced Y/N” represents a flag which indicates which of the paths, i.e. primary or secondary, is currently selected to be used for a respective FEC. Thus, the flag being set or not represents an indicating means indicating a currently assigned delivery path indicator using a separate data element. A “YES” entry means that the load is balanced and that the FEC and the flows assigned thereto are delivered/routed via the secondary path, whereas a “NO” entry denotes that for a FEC concerned, still the primary path is active. In FIG. 5, the active path (primary or secondary) is highlighted in bold.

Thus, in the examples discussed above, the invention provides a load balancing technique where there is a re-routing of flows which is based on conditions identified. This prevents the flows from being broken and prevents out of sequence and lost data packets, as it is the problem in traditional approaches.

The invention relates to traffic engineering applications of the MPLS networks or similar packet data networks. The invention applies specifically to the MPLS edge router design. This invention applies to assigning and choosing an MPLS LSP or ER-LSP based on the network resource management and LSP management. This invention relates also to network resource management and identifying and managing packet data flows (such as IP flows) in MPLS networks. The MPLS enables to map packet data flows into the corresponding FEC and then to a LSP. One of the advantageous applications of this management technique is to enable flow-based load balancing. This invention thus encompasses the aspects of a flow identifier consideration in FTN to determine the next hop (NHFLE) as well as LSP level Resource management.

Both the above tasks or aspects are performed at the ingress MPLS node or the LER. The first aspect corresponds to assigning packets to an existing FEC or a new FEC as per FEC rules at the ingress node based on a flow identifier. The second aspect specifies managing the resource usage over the various LSP and monitoring resources usage of each LSP for a certain time period.

To be more particular, as described above, this invention provides a mechanism to enable a MPLS ingress node to assign new flows to one of the pre-existing FEC as long as that FEC does not violate resource management rules set by the administrator or network operator. Such rule may be based upon the resource availability. If a certain FEC has violated the rule, e.g., exceeding maximum bandwidth assigned to the FEC and/or to the LSP, then a new FEC is created as per the resource availability. Note that the newly created FEC may or not provide the best path towards the egress node for the incoming flow, however other benefits may be introduced instead as described below. Whenever a flow is terminated, the resource usage on the LSP reduces and frees up the usable resources resulting in assigning more flows to that FEC. The FEC may be classified in different ways, such as QoS classes or even finely classified for different QoS sub-classes (like different drop precedence).

According to this invention, each FEC then also indicates the amount of the overall resources used by the flows within the same FEC. When there is a need for path rerouting due to load balancing on the primary path, the NHFLE representing primary path is reassigned to a different NHFLE representing the secondary path. In the process, all the flows using the primary label are rerouted to the secondary path.

The benefit of this approach is that, when there is a need for load balancing, the load balancing algorithm calculations may result in the fact that some amount of traffic occupying a certain amount of resources on the primary path is targeted for rerouting. The resource monitoring function, defined in this invention provides the resource usage information on different FECs belonging to the link or path that is congested. (The table according to FIG. 4 is thus maintained per each link and/or LSP.) The load balancing aspect of the invention then performs load balancing on a certain FEC (or a set) to reroute the FEC and flows associated thereto to the secondary path that is less congested, thus resulting in a flow-based load balancing.

As shown in the FIG. 1B, new flows into the MPLS network are at first assigned to a new (step S22) or existing (step S42) FEC based on the currently available resources on that FEC. If the FEC cannot (step S32) accommodate the new IP flow into it, a new FEC is created (step S22).

Packets of flows are assigned to a certain FEC and then to the next hop from the FTN table and routed based on the MPLS label switching mechanisms. The resource usage on each of the flows are monitored on an aggregate basis per FEC. When the overall load on a certain link or path exceeds safe levels due to congestion, then the load balancing features are become active. The load balancing component first computes how much load must be rerouted to bring the network back to a safe load level and the second step involves identifying the traffic (i.e. FEC and/or flows) to on which to perform the rerouting. In the second step, the information from FEC resource monitor can be used to determine what FEC(s) can be rerouted to secondary path. Then, the FEC are flagged to be rerouted. This usually means that the FEC uses the NHFLE entry corresponding to the secondary path instead of the primary path.

There are several FEC management mechanisms that can be used to perform flow-based load balancing. Namely, one technique of FEC assignments and load balancing is outlined below:
i) FEC categories can be predefined according to different QoS classes or other criteria. For example: FEC category can be assigned to each of EF, AF4, AF3, AF2 and AF1 classes (AF and EF here refers to terminology used in connection with DiffServ QoS architecture, i.e. Assured Forwarding (AF) and Expedited Forwarding (EF) indicate QoS priorities given to traffic based on DiffServ CodePoint (DSCP) markings in a packet). The FEC categories can also be formed uniquely based on the drop precedence within each class. Each FEC allows a certain maximum amount of resources (a particular QoS class) it can occupy on the primary path. For example: EF can occupy 30%, AF4 30%, AF3 10%, AF2 10% and AF1 20%.
ii) Each FEC represented by a set of flows, are limited to a certain amount of resources it is allowed to take based on resource policy management.
iii) When load balancing needs to be performed, any load balancing algorithm can be performed. When a certain amount of resource usage must be rerouted to the secondary path, a FEC is chosen within any class (based on preferences) that can be rerouted to the secondary based on how much resource that FEC occupies to relieve the congestion. For example, when EF flows exceed 30% and there is already congestion, the invention can perform load balancing on EF traffic over 30%. The invention identifies the FEC within the EF traffic that contribute to the excess percentage and then reroutes it to the secondary path. It is not necessary to reroute only the EF traffic but it is also possible to reroute other traffic like the AF1 traffic and switch all or some the FEC with the AF traffic onto secondary path represented by the excess resource utilization.

The ingress node can be designed by adopting the current invention to provide flow-based load balancing. The resource management techniques presented here at the LSP level are useful for policy enforcement and load balancing.

This approach can be used to perform flow-based load balancing in MPLS networks for e.g. IPRAN.

Even though the invention has been described above with a certain focus on the methods involved, it will be appreciated that also the network devices such as routers, in particular ingress routers with correspondingly adapted routing control devices are concerned. Namely, the invention concerns network devices, including a receiver receiving a packet data flow, and a categorizing device, supplied with the received packet data flow. The categorizing device includes a verification mechanism for verifying that the packet data flow belongs to none of the existing packet data delivery categories, a determining mechanism for determining whether characteristics of the packet data flow match one of the existing packet data delivery categories, a checking mechanism for checking whether one of the existing packet data delivery categories conforms to prescribed resource policy rules for one of the existing packet data delivery category, and an assignment mechanism for assigning the packet data flow to the one of the existing packet data delivery category.

Advantageously, the assignment mechanism assigns a new packet data delivery category to the packet data flow in case the determining mechanism outputs a negative result, and also the assignment mechanism assigns a new packet data delivery category to the packet data flow in case the checking mechanism outputs a negative result.

Furthermore, according to one embodiment, the invention concerns network devices, including a receiver for receiving a packet data flow, and a load balancing device. The load balancing device is supplied with the received packet data flow. The load balancing device includes a verification mechanism for verifying whether the packet data flow belongs to one of existing packet data delivery categories. The load balancing device includes an assignment mechanism for assigning a first delivery path indicator for the packet data delivery category. The load balancing device includes a retrieval mechanism for retrieving load conditions prevailing in the network. The load balancing device includes a checking mechanism for checking whether one of the existing packet data delivery categories conforms to prescribed resource policy rules for one of the existing packet data delivery category. The assignment mechanism, in response to a negative result output by the checking mechanism, assigns an alternative delivery path indicator for the packet data delivery category.

Advantageously, the assignment mechanism, in response to a positive result output by the checking mechanism, maintains the assigned delivery path indicator. The network device further includes a delivery means which delivers the packet data flow belonging to one of the existing packet data delivery categories via the path indicated by the currently assigned delivery path indicator.

Accordingly, as described above, the invention concerns a method of load balancing for packet data flows in a packet data network. The method including the steps of receiving a packet data flow, verifying that the packet data flow belongs to one of the existing packet data delivery categories, assigning S21 a first delivery path indicator for the packet data delivery category, retrieving S31 load conditions prevailing in the network, and checking whether one of the existing packet data delivery categories conforms to prescribed resource policy rules for said one existing packet data delivery category. In the case where the step of checking S41 generates a negative result, the method involves assigning S61 an alternative delivery path indicator for the packet data delivery category. The invention also concerns a method of categorizing packet data flows as belonging to a certain packet data delivery category. Further, the invention proposes accordingly configured routers.

While the invention has been described with reference to a preferred embodiment, the description is illustrative of the invention and is not to be construed as limiting the invention. Various modifications and applications may occur to those skilled in the art without departing from the true spirit and scope of the invention as defined by the appended claims.

1. A method of categorizing packet data flows as belonging to a packet data delivery category, the method comprising the steps of:
receiving a packet data flow in an entity;
verifying whether said packet data flow belongs to none of existing packet data delivery categories in the entity;
determining whether characteristics of said packet data flow match one of said existing packet data delivery categories;
checking whether said one of said existing packet data delivery categories conforms to prescribed resource policy rules for said one existing packet data delivery category; and
assigning said packet data flow to said one existing packet data delivery category.

2. A method according to claim 1, further comprising a step of:
assigning a new packet data delivery category to said packet data flow in case said step of determining generates a negative result.

3. A method according to claim 1, further comprising a step of:
assigning a new packet data delivery category to said packet data flow in case said step of checking generates a negative result.

4. A method according to claim 1, wherein said step of checking comprises comparing a maximum usage limit of resources per packet delivery category with a monitored current usage.

5. A method of load balancing for packet data flows in a packet data network, the method comprising the steps of:
receiving a packet data flow in an entity;
detecting an enablement for load balancing for said packet data flow belonging to one of existing packet data delivery categories in the entity;
assigning a first delivery path indicator for a packet data delivery category;
retrieving load conditions prevailing in the network;
checking that said one of said existing packet data delivery categories conforms to prescribed resource policy rules for said one existing packet data delivery category;
and
assigning an alternative delivery path indicator for said packet data delivery category, in case said step of checking generates a negative result.

6. A method according to claim 5, further comprising a step of:
maintaining said assigned first delivery path indicator, in case said step of checking generates a positive result.

7. A method according to claim 5, further comprising a step of:
delivering said packet data flow belonging to said one of existing packet data delivery categories via a path indicated by a currently assigned delivery path indicator.

8. A method according to claim 7, wherein
said step of retrieving load conditions prevailing in the network is repeatedly performed.

9. A method according to claim 5, further comprising a step of:
indicating a currently assigned delivery path indicator using a separate data element.

10. A network device, comprising:
a receiver for receiving a packet data flow in a network device; and
a categorizing device, supplied with said received packet data flow, the categorizing device comprising:
verification means for verifying whether said packet data flow belongs to none of existing packet data delivery categories in the network device,
determining means for determining whether characteristics of said packet data flow match one of said existing packet data delivery categories,
checking means for checking whether said one of said existing packet data delivery categories conforms to prescribed resource policy rules for said one existing packet data delivery category, and
assignment means for assigning said packet data flow to said one existing packet data delivery category.

11. A network device according to claim 10, wherein said assignment means assigns a new packet data delivery category to said packet data flow when said determining means outputs a negative result.

12. A network device according to claim 10, wherein said assignment means assigns a new packet data delivery category to said packet data flow when said checking means outputs a negative result.

13. A network device according to claim 10, wherein said checking means comprises a comparison means comparing a maximum usage limit of resources per packet delivery category with a monitored current usage provided by a monitoring means.

14. A network device, comprising:
a receiver for receiving a packet data flow in a network device; and
a load balancing device, supplied with said received packet data flow, the load balancing device comprising
detection means for detecting an enablement for load balancing for said packet data flow belonging to one of existing packet data delivery categories in the network device,
assignment means for assigning a first delivery path indicator for a packet data delivery category,
retrieval means for retrieving load conditions prevailing in the network, and
checking means for checking whether said one of said existing packet data delivery categories conforms to prescribed resource policy rules for said one existing packet data delivery category,
wherein said assignment means, in response to a negative result output by said checking means, assign an alternative delivery path indicator for said packet data delivery category.

15. A network device according to claim 14, wherein said assignment means, in response to a positive result output by said checking means, maintain an assigned delivery path indicator.

16. A network device according to claim 14, further comprising:
a delivery means for delivering said packet data flow belonging to said one of existing packet data delivery categories via a path indicated by a currently assigned delivery path indicator.

17. A network device according to claim 14, wherein said assignment means comprises an indicating means indicating a currently assigned delivery path indicator using a separate data element.
